(19) United States
(12) Patent Application Publication
(10) Pub. No.: US 2010/0033327 A1
(43) Pub. Date: Feb. 11, 2010

(54) SECURITY ALARM SYSTEM AND METHOD FOR AN ELECTRONIC DEVICE

(75) Inventor: SHOU-SHU KAO, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/481,589

(22) Filed: Jun. 10, 2009

(30) Foreign Application Priority Data
Aug. 8, 2008 (CN) 200810303624.5

(51) Int. Cl. E05B 45/06

(52) U.S. Cl. 340/542

(57) ABSTRACT

A security alarm system and method for an electronic device generates analog sensing signals in the security device if the security device is being unlocked. The system and method further converts the analog sensing signals into digital sensing signals, and generates an alert instruction according to the digital sensing signals.

### BACKGROUND

1. Technical Field

Embodiments of the present disclosure are related to security alarm systems and methods, and in particular to a security alarm system and method for an electronic device.

2. Description of Related Art

Utilizing a common lock to prevent any burglaries is a passive action. Often, a burglary can be only discovered when a user finds that the common lock has been broken or been unlocked. Thus, an alarm system is needed to minimize the risk of burglary.

### BRIEF DESCRIPTION OF THE DRAWINGS

FIG. 1 is a block diagram of one embodiment of an electronic device and a security device comprising a security alarm system.

FIG. 2 is a flowchart of one embodiment of a security alarm method for an electronic device.

### DETAILED DESCRIPTION

All of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

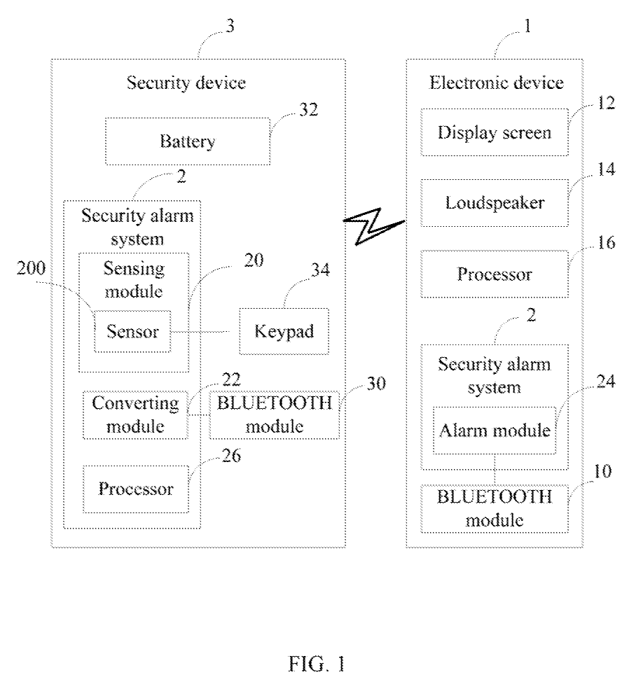

FIG. 1 is a block diagram of one embodiment of an electronic device 1 and a security device 3 comprising a security alarm system 2. The security alarm system 2 generates and transmits an alert instruction to the electronic device 1 if the security device 3 becomes unlocked. The electronic device 1 and the security device 3 have a BLUETOOTH module 10 and a BLUETOOTH module 30 respectively, to establish a wireless connection for transmitting data between the electronic device 1 and the security device 3.

The security device 3 includes a battery 32 to provide power for the security device 3. In one embodiment, the battery 32 may be a rechargeable battery or a common battery. In other embodiment, the security device 3 may be connected to an electric power source directly.

Depending on the embodiment, the security device 3 may be a coded lock or a key lock. The coded lock may be a touch-tone coded lock, a rotary disk lock or any other type of coded lock. In this exemplary embodiment, the security device 3 is a touch-tone coded lock. The security device 3 further includes a keypad 34 for a user to input a password to unlock the security device 3.

In one embodiment, the electronic device 1 may be a desktop computer, a notebook computer, or a mobile phone for receiving signals transmitted from the security device 3, and generating an alert instruction according to the signals. The electronic device 1 includes a display screen 12, a loudspeaker 14, and a processor 16. The display screen 12 outputs a graphics alert according to the alert instruction. The loudspeaker 14 outputs an audible alert according to the alert instruction.

The security alarm system 2 can be started according to the below steps. In a first step, the security device 3 and the electronic device 1 are powered on. Next, a wireless BLUETOOTH connection is established between the security device 3 and the electronic device 1.

In the embodiment of the present disclosure, the security alarm system 2 includes a sensing module 20, a converting module 22, an alarm module 24, and a processor 26. The modules 20 and 22 may be used to perform one or more operations of the security device 3. The module 22 may be used to perform one or more operations of the electronic device 1. Depending on embodiment, the security device 3 may include one or more specialized or general purpose processors, such as a processor 26 for executing at least one operation for the modules 20 and 22. Depending on embodiment, the electronic device 1 may include one or more specialized or general purpose processors, such as the processor 16 for executing at least one operation for the module 24.

The sensing module 20 is operable to detect whether the security device 3 is being unlocked, and generate analog sensing signals if the security device 3 is being unlocked. In this exemplary embodiment, the sensing module 20 includes a sensor 200 to detect whether the keypad 34 is being operated. If the keypad 34 is being operated, the sensing module 20 determines that the security device 3 is being unlocked and generates the analog sensing signals, and transmits the analog sensing signals to the converting module 22.

The converting module 22 is operable to receive the analog sensing signals, convert the analog sensing signals into digital sensing signals, and transmit the digital sensing signals to the BLUETOOTH module 30 of the security device 3. The BLUETOOTH module 30 transmits the digital sensing signals to the BLUETOOTH module 10 of the electronic device 1 via the wireless connection. The BLUETOOTH module 10 of the electronic device 1 receives the digital sensing signals and sends the digital sensing signals to the alarm module 24.

The alarm module 24 is operable to receive the digital sensing signals and generate an alert instruction according to the digital sensing signals and transmit the alert instruction to the display screen 12 and/or the loudspeaker 14. The alert instruction includes a visual alert instruction and an audio alert instruction. If the alert instruction is the visual alert instruction, the alarm module 24 transmits the visual alert instruction to the display screen 12 of the electronic device 1 to output the graphics alert. If the alert instruction is the audio alert instruction, the alarm module 24 transmits the audio alert instruction to the loudspeaker 14 of the electronic device 1 to output the audible alert.

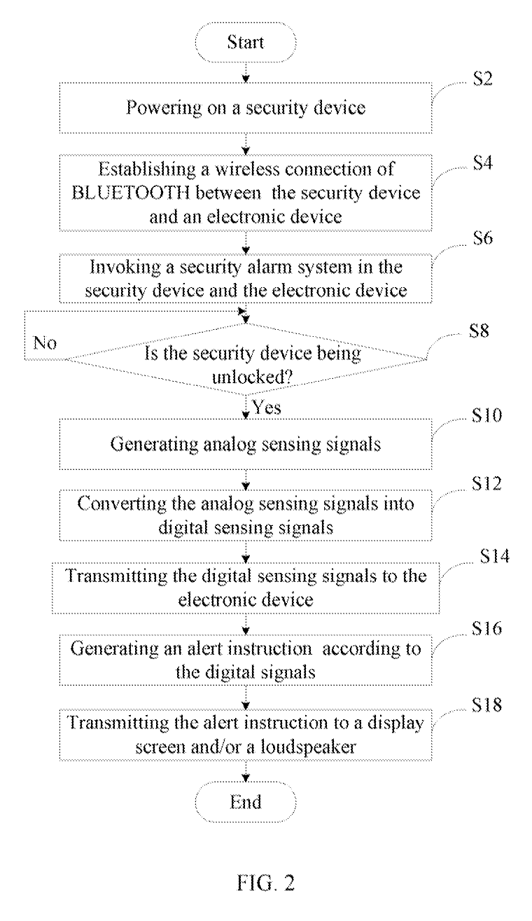

FIG. 2 is a flowchart of one embodiment of a security alarm method for the electronic device 1. Depending on the embodiment, additional blocks may be added, others deleted, and the ordering of the blocks may be changed. Firstly, in block S2, the electronic device 1 is powered on.

In block S4, a wireless connection between the BLUETOOTH module 30 of the security device 3 and the BLUETOOTH module 10 of the electronic device 1 is established.

In block S6, the security alarm system 2 in the security device 3 and the electronic device 1 is invoked.

In block S8, the sensor 200 detects whether the security device 3 is being unlocked. If the keypad 34 of the security device 3 is being operated, the sensor 200 determines the security device 3 is being unlocked, the procedure goes to S10. Otherwise, if the keypad 34 of the security device 3 is not being operated, the sensor 200 determines the security device 3 is not being unlocked, the procedure goes to S8.

In block S10, the sensing module 20 generates analog sensing signals, and transmits the analog sensing signals to the converting module 22.

In block S12, the converting module 22 converts the analog sensing signals into digital sensing signals, and transmits the digital sensing signals to the BLUETOOTH module 30 of the security device 3.

In block S14, the BLUETOOTH module 30 transmits the digital sensing signals to the BLUETOOTH module 10 of the electronic device 1 via the wireless connection. The BLUETOOTH module 10 of the electronic device 1 receives the digital sensing signals and sends the digital sensing signals to the alarm module 24.

In block S16, the alarm module 24 receives the digital sensing signals and generates the alert instruction according to the digital sensing signals.

In block S18, the alarm module 24 transmits the alert instruction to the display screen 12 and/or the loudspeaker 14, then the display screen 12 outputs the graphics alert if the alert instruction is a visual alert instruction, and the loudspeaker 14 outputs the audible alert if the alert instruction is a audio alert instruction.

It should be emphasized that the described inventive embodiments are merely possible examples of implementations, and set forth for a clear understanding of the principles of the present disclosure. Many variations and modifications may be made to the above-described inventive embodiments without departing substantially from the spirit and principles of the present disclosure. All such modifications and variations are intended to be included herein within the scope of this disclosure and the above-described inventive embodiments, and the present disclosure is protected by the following claims.

What is claimed is:

1. An electronic device comprising a security alarm system, the device comprising:
a wireless BLUETOOTH module in communication with a security device;
a display screen;
a loudspeaker;
a sensing module operable to detect whether the security device is being unlocked, and to generate analog sensing signals if the security device is being unlocked;
a converting module operable to convert the analog sensing signals into digital sensing signals, and transmit the digital sensing signals to the electronic device via the wireless BLUETOOTH connection; and
an alarm module operable to generate an alert instruction according to the digital sensing signals and transmit the alert instruction to the display screen and/or the loudspeaker.

2. The system according to claim 1, wherein the alert instruction comprises a visual alert instruction and an audio alert instruction.

3. The system according to claim 2, wherein the alarm module is further operable to transmit the visual alert instruction to the display screen of the electronic device.

4. The system according to claim 2, wherein the alarm module is further operable to transmit the audio alert instruction to the loudspeaker of the electronic device.

5. The system according to claim 1, wherein the security device comprises a coded lock and a keylock.

6. A security alarm method for an electronic device, the method comprising:
establishing a wireless BLUETOOTH connection between a security device and the electronic device;
invoking a security alarm system in the electronic device and the security device;
detecting whether the security device is being unlocked by a sensor in the security device;
generating analog sensing signals in the security device if the security device is being unlocked;
converting the analog sensing signals into digital sensing signals;
transmitting the digital sensing signals to the electronic device via the wireless BLUETOOTH connection;
generating an alert instruction according to the digital sensing signals; and
transmitting the alert instruction to a display screen and/or a loudspeaker.

7. The method according to claim 6, wherein the alert instruction comprises a visual alert instruction and an audio alert instruction.

8. The method according to claim 7, wherein the visual alert instruction is transmitted to the display screen of the electronic device.

9. The method according to claim 7, wherein the audio alert instruction is transmitted to the loudspeaker of the electronic device.

10. The method according to claim 6, wherein the security device comprises a coded lock and a keylock.

11. A storage medium having stored thereon instructions that, when executed by a processor, causing the processor to perform security alarm method for an electronic device, the method comprising:
establishing a wireless BLUETOOTH connection between a security device and the electronic device;
invoking a security alarm system in the electronic device and the burglar system in the security device;
detecting whether the security device is being unlocked by a sensor in the security device;
generating analog sensing signals in the security device if the security device is being unlocked;
converting the analog sensing signals into digital sensing signals;
transmitting the digital sensing signals to the electronic device via the wireless BLUETOOTH connection;
generating an alert instruction according to the digital sensing signals; and
transmitting the alert instruction to a display screen and/or a loudspeaker.

12. The medium according to claim 11, wherein the alert instruction comprises a visual alert instruction and an audio alert instruction.

13. The medium according to claim 12, wherein the visual alert instruction is transmitted to the display screen of the electronic device.

14. The medium according to claim 12, wherein the audio alert instruction is transmitted to the loudspeaker of the electronic device.

15. The medium according to claim 11, wherein the security device comprises a coded lock and a key lock.
